(19) United States
(12) Patent Application Publication
(10) Pub. No.: US 2024/0297814 A1
(43) Pub. Date: Sep. 5, 2024

(54) JOINT SENSING METHOD AND RELATED USER EQUIPMENT FOR ORTHOGONAL FREQUENCY DOMAIN MULTIPLEXING COMMUNICATION SYSTEM

(71) Applicant: MEDIATEK INC., Hsin-Chu (TW)

(72) Inventors: Rui Zhang, San Jose, CA (US); Shiauhe Tsai, San Jose, CA (US)

(73) Assignee: MEDIATEK INC., Hsin-Chu (TW)

(21) Appl. No.: 18/590,966

(22) Filed: Feb. 29, 2024

Related U.S. Application Data
(60) Provisional application No. 63/487,891, filed on Mar. 2, 2023.

(51) Int. Cl. H04L 27/26; H04L 5/00

(52) U.S. Cl. CPC H04L 27/2634; H04L 5/0007; H04L 5/0051; H04L 27/2605

(57) ABSTRACT

A joint sensing method for an orthogonal frequency domain multiplexing communication system, comprises performing inverse fast Fourier transform for an OFDM reference signal symbol to obtain a first plurality of subsets of the OFDM RS symbol; removing, by a receiver of the OFDM communication system, cyclic prefix of a plurality of resource elements of the OFDM RS symbol and at least one of the first plurality of subsets of the OFDM RS symbol to obtain a second plurality of subsets of the OFDM RS symbol; and performing, by the receiver of the OFDM communication system, a phase compensation for the second plurality of subsets of the OFDM RS symbol to obtain the third plurality of subsets of the OFDM RS symbol; and performing fast Fourier transform for the third plurality of subsets of the OFDM RS symbol; wherein the OFDM RS symbol is of a comb structure.

### CROSS REFERENCE TO RELATED APPLICATIONS

This application claims the benefit of U.S. Provisional Application No. 63/487,891, filed on Mar. 2, 2023. The content of the application is incorporated herein by reference.

### BACKGROUND

When the conventional joint communication and sensing are applied with orthogonal frequency domain multiplexing (OFDM) technique, the sensing algorithms in the frequency domain (e.g., MUSIC and 2D FFT) are limited by cyclic prefix (CP) duration. Typically, the CP duration determines the maximum time delay (distance), which can be detected in the frequency domain. A conventional technique to extend the maximum time delay without ISI adopts the extended CP to reduce the transmission efficiency. Another method is to increase the symbol duration, which results in decreased Doppler frequency resolution and tolerance.

In addition, conventional techniques of sensing object's distance and velocity via measured signal delay and Doppler frequency shift detection are commonly utilized in radar engineering. The object's distance equals the signal delay multiplied by the speed of electromagnetic wave, and the object's velocity relative to the radar, divided by the carrier frequency, translates to the Doppler frequency shift. In addition, communication signals possess similar radio characteristics and could be reused for sensing.

However, conventional 5G NR positioning reference signal (PRS) only considers delay detection, i.e. distance, for triangulation. Requirements for Doppler shift, i.e. object's velocity, are neglected.

Therefore, improvements are necessary to the conventional technique.

### SUMMARY

In light of this, the present invention provides a joint sensing method and related user equipment (UE) for an orthogonal frequency domain multiplexing (OFDM) communication system to extend a maximum time delay and adapt a maximal unambiguous velocity and distance.

An embodiment of the present invention provides a joint sensing method for an orthogonal frequency domain multiplexing (OFDM) communication system includes performing inverse fast Fourier transform (IFFT) for an OFDM reference signal (RS) symbol to obtain a first plurality of subsets of the OFDM RS symbol; removing, by a receiver of the OFDM communication system, cyclic prefix (CP) of a plurality of resource elements (RE) of the OFDM RS symbol and at least one of the first plurality of subsets of the OFDM RS symbol to obtain a second plurality of subsets of the OFDM RS symbol; and performing, by the receiver of the OFDM communication system, a phase compensation for the second plurality of subsets of the OFDM RS symbol to obtain the third plurality of subsets of the OFDM RS symbol; and performing, by the receiver of the OFDM communication system, fast Fourier transform (FFT) for the third plurality of subsets of the OFDM RS symbol; wherein the OFDM RS symbol is of a comb structure.

Another embodiment of the present invention provides a user equipment (UE) of an orthogonal frequency domain multiplexing (OFDM) communication system, comprises a wireless transceiver, configured to receive a first plurality of subsets of the OFDM RS symbol from a service network; and a controller, configured to remove cyclic prefix (CP) of a plurality of resource elements (RE) of an OFDM reference signal (RS) symbol and at least one of the first plurality of subsets of the OFDM RS symbol to obtain a second plurality of subsets of the OFDM RS symbol; to perform a phase compensation for the second plurality of subsets of the OFDM RS symbol to obtain the third plurality of subsets of the OFDM RS symbol; and to perform fast Fourier transform (FFT) for the third plurality of subsets of the OFDM RS symbol; wherein the OFDM RS symbol is of a comb structure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to an embodiment of the present invention.

FIG. 2 is a schematic diagram of a comb structure of an RS pattern according to an embodiment of the present invention.

FIG. 3 is a schematic diagram of a specific comb structure of an RS pattern according to an embodiment of the present invention.

FIGS. 4, 5, 6, 7, 8, 9 are schematic diagrams of a contour of the 2D FFT ambiguity function according to an embodiment of the present invention.

FIGS. 10(a), 10(b), 10(c), 10(d), 10(e), 10(f) are schematic diagrams of a contour of the 2D ambiguity function according to an embodiment of the present invention.

FIGS. 11(a), 11(b), 11(c), 11(d), 11(e), 11(f) are schematic diagrams of a contour of the 2D ambiguity function according to an embodiment of the present invention.

### DETAILED DESCRIPTION

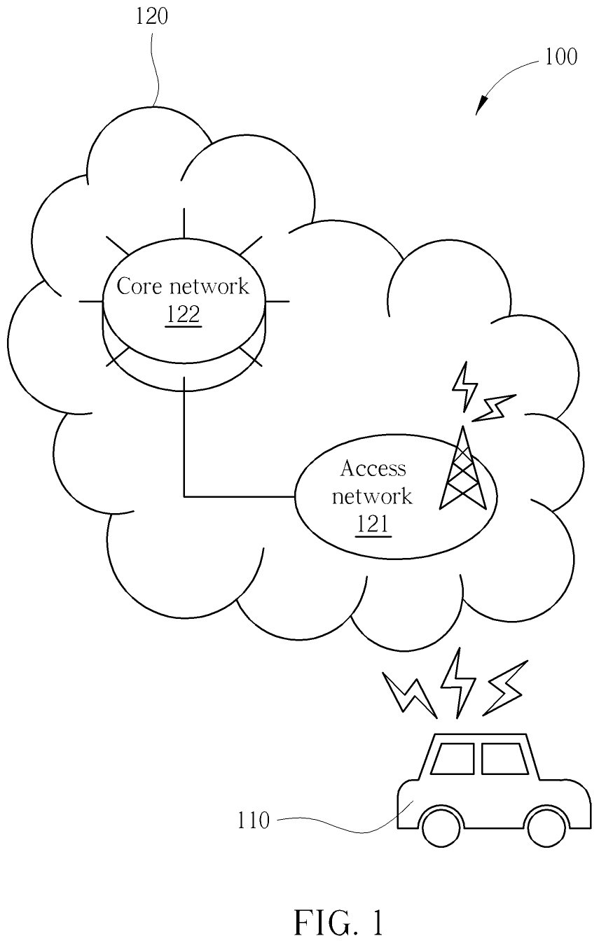

FIG. 1 is a schematic diagram of a wireless communication network 100 according to an embodiment of the present invention.

As shown in FIG. 1, the wireless communication network 100 may include a user equipment (UE) 110 and a service network 120, wherein the UE 110 may be wirelessly connected to the service network 120 for obtaining mobile services and performing cell measurements on the cell (s) of the service network 120.

The UE 110 may be a feature phone, a smartphone, a panel Personal Computer (PC), a laptop computer, a moving vehicle or any wireless communication device supporting the wireless technology (e.g., the 5G NR technology) utilized by the service network 120. In another embodiment, the UE 110 may support more than one wireless technology. For example, the UE may support the 5G NR technology and a legacy 4G technology, such as the LTE/LTE-A/TD-LTE technology.

The service network 120 includes an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). Each of the access network 121 and the core network 122 may comprise one or more network nodes for carrying out said functions.

In one embodiment, the service network 120 may be a 5G NR network, and the access network 121 may be a Radio Access Network (RAN) and the core network 122 may be a Next Generation Core Network (NG-CN).

A RAN may include one or more cellular stations, such as next generation NodeBs (gNBs), which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

An NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QOS). Based on the information, the PCF determines policies about mobility and session management to make the AMF and the SMF operate properly. The AUSF stores data for authentication of UEs, while the UDM stores subscription data of UEs.

In another embodiment, the service network 120 may be an LTE/LTE-A/TD-LTE network, and the access network 121 may be an Evolved-Universal Terrestrial Radio Access Network (E-UTRAN) and the core network 122 may be an Evolved Packet Core (EPC).

An E-UTRAN may include at least one cellular station, such as an evolved NodeB (eNB) (e.g., macro eNB, femto eNB, or pico eNB), each of which may form a cell for providing mobile services to the UE 110. For example, the UE 110 may camp on one or more cells formed by one or more eNBs, wherein the cells which the UE 110 is camped on may be referred to as serving cells, including a Pcell and one or more Scells.

An EPC may include a Home Subscriber Server (HSS), Mobility Management Entity (MME), Serving Gateway (S-GW), and Packet Data Network Gateway (PDN-GW or P-GW).

It should be understood that the wireless communication network 100 described in the embodiment of FIG. 1 is for illustrative purposes only and is not intended to limit the scope of the application. For example, the wireless communication network 100 may include both a 5G NR network and a legacy network (e.g., an LTE/LTE-A/TD-LTE network, or a WCDMA network), and the UE 110 may be wirelessly connected to both the 5G NR network and the legacy network.

According to an embodiment of the present invention, a criteria of tunable time delay for single comb design is applied to either new 6G joint communication sensing, or improvement over existing 5G NR, reference signal (RS) patterns.

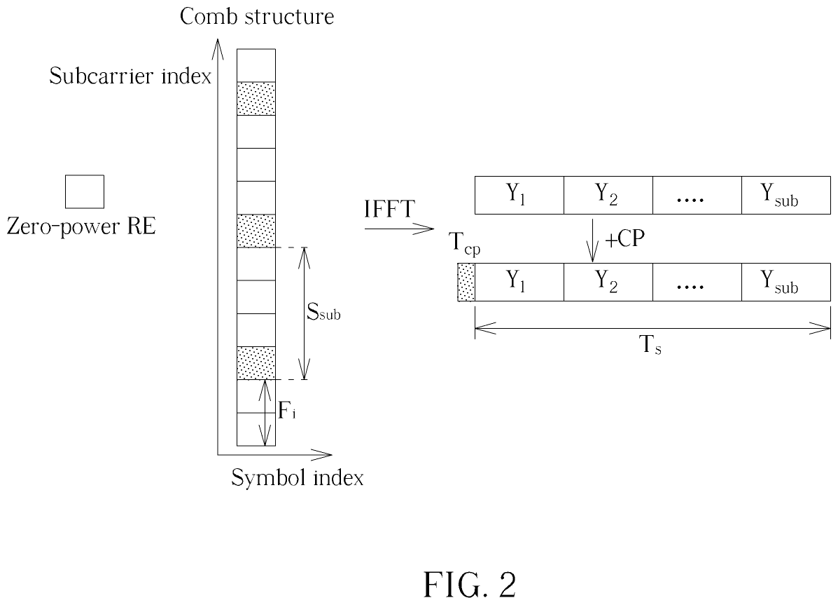

Please refer to FIG. 2, which is a schematic diagram of a comb structure of an RS pattern according to an embodiment of the present invention. The RS pattern includes a plurality of RS resource elements (RE).

As shown in FIG. 2, several subsets containing the same information within the time samples of one OFDM symbol. Let S_{sub} unit in subcarrier numbers denotes a spacing of non-zero REs in a frequency domain, S_{sym} unit in symbol numbers denotes a spacing of the RS symbols in a time domain, and Fᵢ unit in subcarrier numbers be a staggering offset in the frequency domain of the iₜₕ RS symbol. Then, the OFDM samples could be divided to S_{sub} subsets, e.g., S_{sub}=4, four subsets as shown in FIG. 2.

For any subsets Yᵢ and Yⱼ (i≠j), the difference between Yᵢ and Yⱼ is only a constant phase rotation. The subsets may be treated as CP and removed before FFT at the receiver side and thus the scheme in FIG. 2 may achieve a flexible CP duration tuning as shown in the below examples:
1) Only removing CP and perform FFT at the receiver side. The maximum time delay that the scheme may obtain is exactly CP time duration T_{cp};
2) Treating CP and Y₁ as an extended CP and keep Y₂ to Y₄ for FFT. The maximum time delay that the scheme may obtain is thus extended to min(T_{cp}+¼Tₛ, Tₛ), where Tₛ is OFDM symbol duration;
3) Treating CP and Y₁, Y₂ as an extended CP and keep Y₃ and Y₄ for FFT. The maximum time delay that the scheme may obtain is thus extended to min(T_{cp}+½Tₛ, Tₛ), where Tₛ is OFDM symbol duration;
4) Treating CP and Y₁, Y₂, Y₃ as an extended CP and keeping Y₄ for FFT. The maximum time delay that the scheme may obtain is thus extended to min(T_{cp}+¾Tₛ, Tₛ), where Tₛ is OFDM symbol duration.

As illustrated in FIG. 2, Tₛ denotes an OFDM duration, Top denotes a CP duration, T=T_{cp}+Tₛ denotes the CP-added OFDM symbol duration, and Xᵢ denotes a frequency sequence of the iₜₕ comb RS with a length of N. Assuming a small Doppler frequency (i.e., |f_{D}|<fₘₐₓ), the Doppler frequency introduces a constant phase rotation for all time samples of one OFDM symbol.

For the comb structure in FIG. 2, the time sequence of the iₜₕ OFDM RS symbol after IFFT is Y with a length of N in formula (1):

$$Y ( n ) = {\sum }_{k = 0}^{\frac{N}{{S}_{sub}}} {X}_{i} ( {kS}_{sub} + {F}_{i} ) {e}^{\frac{j 2 π ( {kS}_{sub} + {F}_{i} ) n}{N}} , n = 0 , 1 , … N - 1 \qquad ( 1 )$$

Y may be divided as S_{sub} subsets, where the h-th subset is Yₕ with a length of N/S_{sub}:

$${Y}_{h} = \{ Y ( n ) \} , ∈ [ \frac{( h - 1 ) N}{{S}_{sub}} + 1 , \frac{hN}{{S}_{sub}} ] \qquad ( 2 )$$

$$and {Y}_{h} = {Y}_{1} {e}^{j ( \frac{2 π {F}_{i} h}{{S}_{sub}} )} \qquad ( 3 )$$

Let the transmitted time sequence of one CP added OFDM symbol be Z with a length of N+N_{cp} and

$$Z ( n ) = {\sum }_{k = 0}^{\frac{N}{{S}_{sub}}} {X}_{i} ( {kS}_{sub} + {F}_{i} ) {e}^{\frac{j 2 π ( {kS}_{sub} + {F}_{i} ) ( N - {N}_{cp} + n )}{N}} , n = 0 , 1 , … N + {N}_{cp} - 1 \qquad ( 4 )$$

After removing the extended CP (first

$${N}_{cp} + \frac{lN}{{S}_{sub}}$$

samples, l=0, 1, . . . . S_{sub}−1), the received time sequence of the i-th OFDM symbol with a delay and a phase rotation caused by Doppler is represented as:

$$\begin{matrix}G ( m ) = Z ( \frac{Nl}{{S}_{sub}} + {N}_{cp} + m - {N}_{τ} ) \cdot {e}^{j 2 π {f}_{D} {iTS}_{sym}} \\ = {\sum }_{k = 0}^{\frac{N}{{S}_{sub}}} {X}_{i} ( {kS}_{sub} + {F}_{i} ) {e}^{\frac{j 2 π ( {kS}_{sub} + {F}_{i} ) ( N - {N}_{cp} + \frac{Nl}{{S}_{sub}} + {N}_{cp} + m - {N}_{τ} )}{N}} {e}^{j 2 π {f}_{D} {iTS}_{sym}} \\ = {\sum }_{k = 0}^{\frac{N}{{S}_{sub}}} {X}_{i} ( {kS}_{sub} + {F}_{i} ) {e}^{\frac{j 2 π ( {kS}_{sub} + {F}_{i} ) ( \frac{Nl}{{S}_{sub}} + m - {N}_{τ} )}{N}} {e}^{j 2 π {f}_{D} {iTS}_{sym}}\end{matrix} \qquad ( 5 )$$

$$where 0 \leq {N}_{τ} \leq min ( {N}_{cp} + \frac{Nl}{{S}_{sub}} , N ) , m = 0 , 1 , .. \frac{N ( {S}_{sub} - l )}{{S}_{sub}} - 1 ) .$$

In order to recover the non-zero REs from G, the receiver side should perform phase compensation before FFT for extended guard interval design. The receiver side may perform the following phase rotation procedure before FFT, that is:

$${G}^{′} ( m ) = G ( m ) {e}^{- \frac{j 2 π {F}_{i} ( \frac{Nl}{{S}_{sub}} + m )}{N}} = {{\sum }^{\frac{N}{{S}_{sub}}}}_{k = 0} {X}_{i} ( {kS}_{sub} + {F}_{i} ) {e}^{\frac{- j 2 π ( {kS}_{sub} + {F}_{i} ) {N}_{τ}}{N}} \cdot {e}^{j 2 π {f}_{D} {iTS}_{sym}} \cdot {e}^{\frac{j 2 π {kS}_{sub} m}{N}} , m = 0 , 1 , .. \frac{N ( {S}_{sub} - l )}{{S}_{sub}} - 1 \qquad ( 6 )$$

Then by performing FFT on G′, a sequence B with a length of (S_{sub}−l)N/S_{sub} is obtained and

$$B ( {k}^{′} ) = {\sum }_{m = 0}^{\frac{( {S}_{sub} - l ) N}{{S}_{sub}} - 1} {G}^{′} ( m ) {e}^{j \frac{- 2 π {k}^{′} {S}_{sub} m}{( {S}_{sub} - l ) N}} = {\sum }_{m = 0}^{\frac{( {S}_{sub} - l ) N}{{S}_{sub}} - 1} ( {\sum }_{k = 0}^{\frac{N}{{S}_{sub}}} {X}_{i} ( {kS}_{sub} + {F}_{i} ) {e}^{\frac{- j 2 π ( {kS}_{sub} + F ) {N}_{τ}}{N}} \cdot {e}^{j 2 π {f}_{D} {iTS}_{sym}} \cdot {e}^{\frac{j 2 π {kS}_{sub} m}{N}} ) {e}^{j \frac{- 2 π {k}^{′} {S}_{sub} m}{( {S}_{sub} - l ) N}} = \{ \begin{matrix}( {S}_{sub} - l ) \cdot {X}_{i} ( {kS}_{sub} + {F}_{i} ) {e}^{j 2 π {f}_{D} {iTS}_{sym}} {e}^{- \frac{j 2 π {N}_{τ} ( {kS}_{sub} + {F}_{i} )}{N}} , when {k}^{′} = ( {S}_{sub} - l ) k , k = 0 , 1 , … , \frac{N}{{S}_{sub}} \\ 0 , otherwise\end{matrix} \qquad ( 7 )$$

Then the frequency-domain sequence of the i-th RS symbol for sensing algorithm analysis may be re-assembled as:

$${X}_{i}^{′} ( {k}^{′} {S}_{sub} / ( {S}_{sub} - 1 ) + {F}_{i} ) = B ( {k}^{′} )$$

$${X}_{i}^{′} ( {k}^{′} {S}_{sub} / ( {S}_{sub} - 1 ) + {F}_{i} ) = \{ \begin{matrix}B ( {k}^{′} ) , when B ( {k}^{′} ) \neq 0 \\ 0 , otherwise\end{matrix}$$

Therefore, Xᵢ′ can be further simplified as:

$${X}_{i}^{′} ( j ) = ( {S}_{sub} - l ) \cdot {X}_{i} ( j ) {e}^{j 2 π {f}_{D} {iTS}_{sym}} {e}^{- \frac{j 2 π {N}_{τ} j}{N}} , j = 0 , 1 … . , N - 1 , where j = 0 , 1 … . , N - 1 \qquad ( 8 )$$

Thus, the tunable maximum time delay without ISI that the scheme supports without ISI is

$$min ( {T}_{cp} + \frac{l}{{S}_{sub}} {T}_{s} , {T}_{s} ) .$$

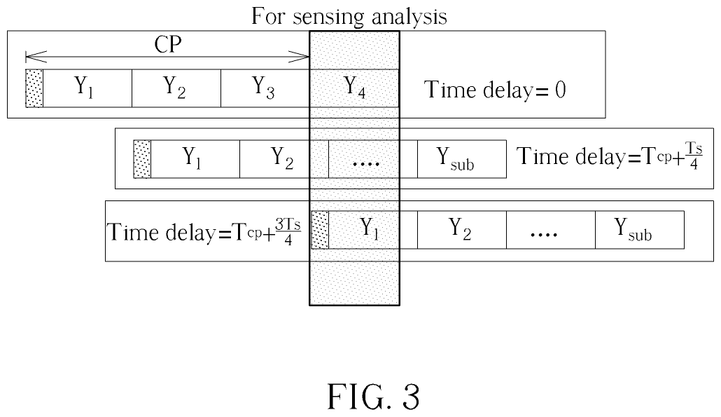

FIG. 3 illustrates an instance of l=S_{sub}−1, S_{sub}=4. Note that, there is a trade-off between signal energy loss and maximum time delay with different choices of l. Larger l supports larger maximum time delay but yields lower signal energy for sensing algorithms analysis.

Therefore, the time domain property of the comb structure and a flexible tuning of maximum time delay may be achieved with the above sensing algorithms according to an embodiment of the present invention.

In addition, according to an embodiment of the present invention, the staggering comb structure of reference signal (RS) pattern for the OFDM communication system may be applied to the sensing algorithms, e.g., iterative adaptive approaches (IAA), multiple signal classification (MUSIC), comprehensive sensing and 2D FFT, of the receiver side of the OFDM communication system after the FFT is performed.

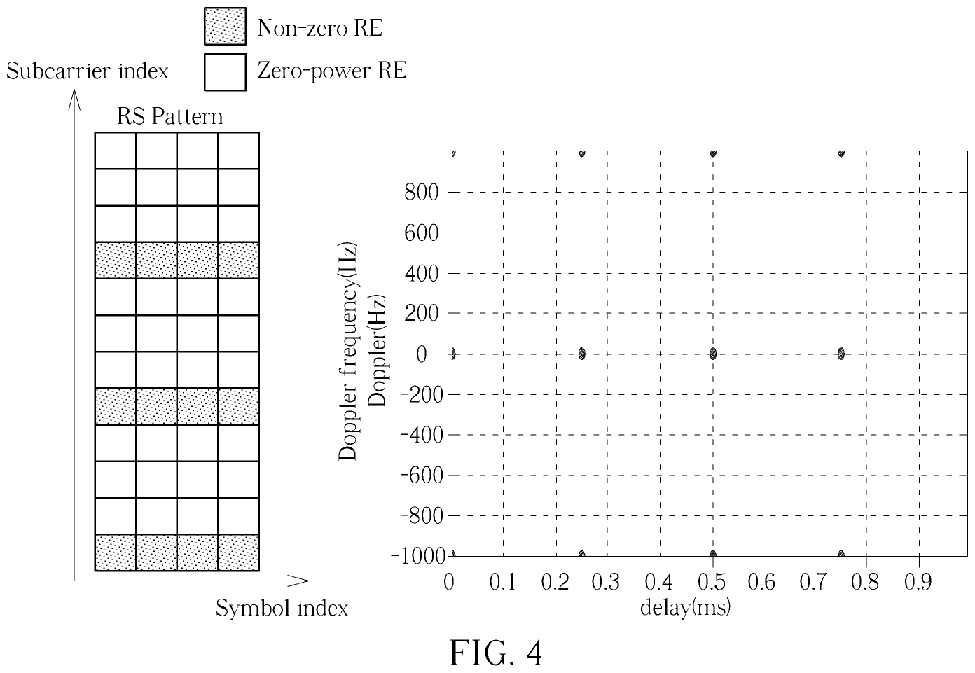

FIGS. 4, 5, 6, 7 illustrate ambiguity peaks with (0, 0) of a contour of the 2D FFT ambiguity function in the delay-Doppler domain.

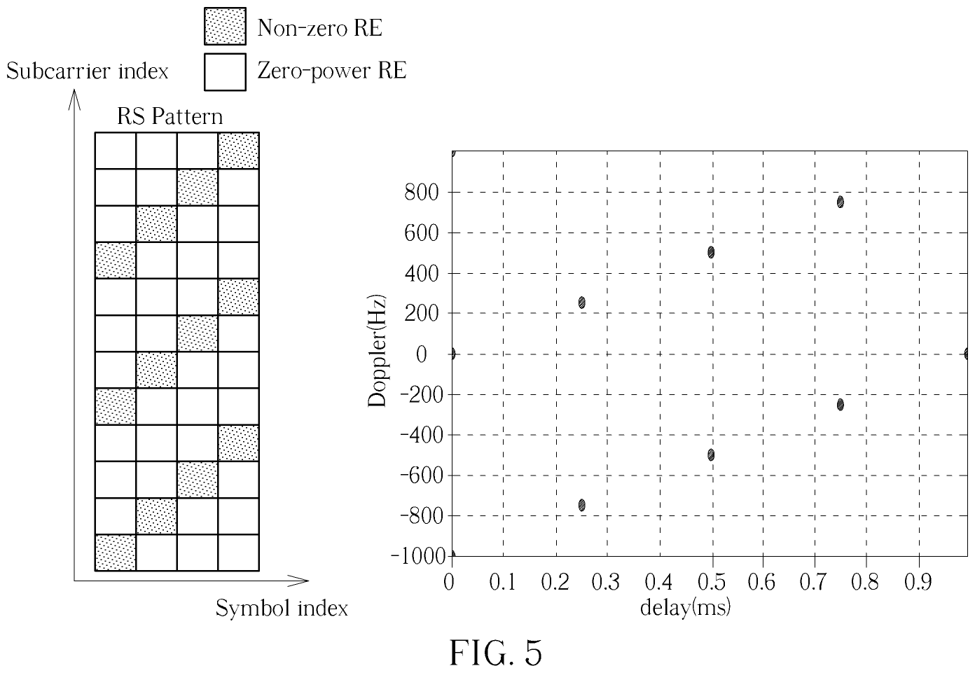

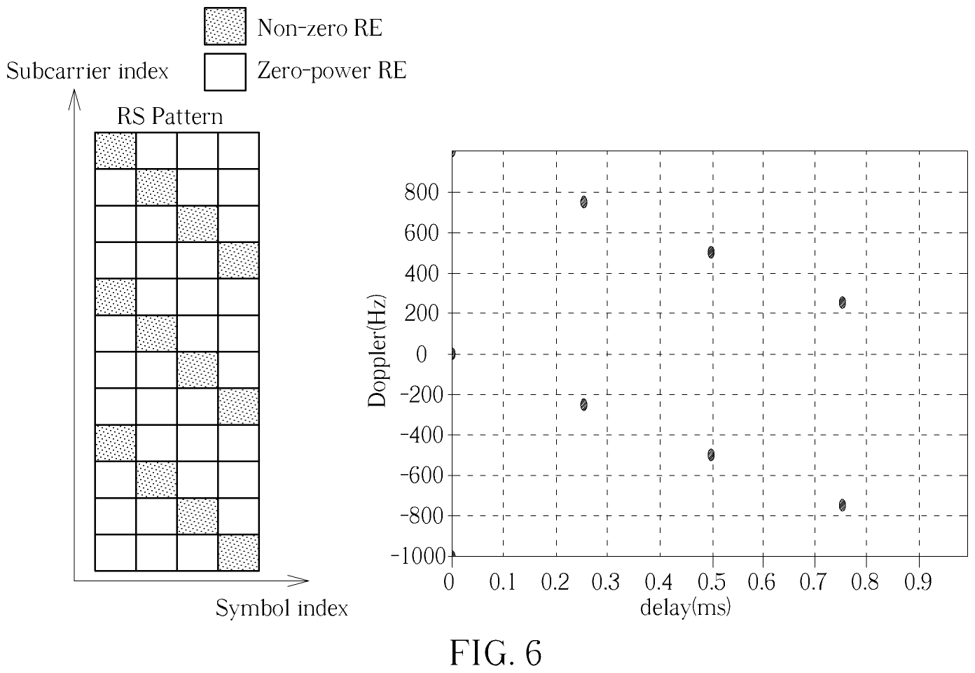

As shown in FIG. 3, a specific comb structure, such as the one with constant Fᵢ=0, ∀i∈{1, 2, . . . , 4}, introduces the time delay ambiguities using the sensing algorithms in frequency domain (e.g., 2D FFT). In this case, the staggered comb pattern may be adopted throughout different OFDM symbols to eliminate side peaks in the time domain as illustrated in FIG. 5 and FIG. 6.

The frequency-domain sequence of the i-th RS symbol for sensing algorithm analysis is:

$${X}_{i}^{′} ( j ) = ( {S}_{sub} - l ) \cdot {X}_{i} ( j ) {e}^{j 2 π {f}_{D} {iTS}_{sym}} {e}^{- \frac{j 2 π {N}_{τ} j}{N}} , j = 0 , 1 … . , N - 1 \qquad ( 9 )$$

Thus, the tunable maximum time delay without ISI that the scheme supports without ISI is

$$min ( {T}_{cp} + \frac{l}{{S}_{sub}} {T}_{s} , {T}_{s} ) .$$

Note that, there is a trade-off between signal energy loss and maximum time delay with different choices of l. Larger l supports larger maximum time delay but yields lower signal energy for sensing algorithms analysis. Moreover, staggered comb patterns may be adopted to eliminate the side peaks and eliminate the time delay ambiguities of the ambiguity function produced by the sensing algorithms.

For 2D FFT algorithm, the following 2D FFT operation is performed to a sequence of received OFDM symbols without modulation {Aᵢ}.

$${A}_{i} ( {k}_{1} ) = \{ \begin{matrix}\frac{{X}_{i}^{′} ( {k}_{1} )}{( {S}_{sub} - l ) {X}_{i} ( j )} = {e}^{j 2 π {f}_{D} {iTS}_{sym}} {e}^{- \frac{j 2 π {N}_{τ} {k}_{1}}{N}} , {k}_{1} = {kS}_{sub} + {F}_{i} , k = 0 , 1 , .. \frac{N}{{S}_{sub}} \\ 0 , otherwise\end{matrix} \qquad ( 10 )$$

for k₁=0, 1 . . . N−1, i=0, 1, . . . M−1. The 2-D ambiguity function is

$$\begin{matrix}P ( p , q ) = {\vert {{\sum }^{N - 1}}_{{k}_{1} = 0} ( {{\sum }^{M - 1}}_{i = 0} {A}_{i} ( {k}_{1} ) {e}^{- \frac{j 2 π {qiS}_{sym}}{M}} ) {e}^{\frac{j 2 π {pk}_{1}}{N}} \vert}^{2} \\ = {\vert {{\sum }^{\frac{N}{{S}_{sub}} - 1}}_{k = 0} ( {{\sum }^{M - 1}}_{i = 0} {e}^{j 2 π {f}_{D} {iTS}_{sym}} {e}^{- \frac{j 2 π {N}_{τ} ( {kS}_{sub} + {F}_{i} )}{N}} {e}^{- \frac{j 2 π {qiS}_{sym}}{M}} ) {e}^{\frac{j 2 π p ( {kS}_{sub} + {F}_{i} )}{N}} \vert}^{2} \\ = {\vert {{\sum }^{\frac{N}{{S}_{sub}} - 1}}_{k = 0} {e}^{- \frac{j 2 π {N}_{τ} {kS}_{sub}}{N}} {e}^{\frac{j 2 π {pkS}_{sub}}{N}} {{\sum }^{M - 1}}_{i = 0} {e}^{j 2 π {f}_{D} {iTS}_{sym}} {e}^{- \frac{j 2 π {qiS}_{sym}}{M}} {e}^{- \frac{j 2 π {N}_{τ} {F}_{i}}{N}} {e}^{\frac{j 2 π {pF}_{i}}{N}} \vert}^{2}\end{matrix} \qquad ( 11 )$$

For the first summation of formula (11), the maximum value is obtained at

$${e}^{- \frac{j 2 π {N}_{τ} {kS}_{sub}}{N}} {e}^{\frac{j 2 π {pkS}_{sub}}{N}} = 1 ,$$

that is

$$\frac{{pS}_{sub}}{N} - \frac{{N}_{τ} {S}_{sub}}{N} = {z}_{1} ∈ ℤ .$$

Then at the 2-D FFT spectrum, there will be a peak at the p-axis.

$$p - {N}_{τ} = \frac{{Nz}_{1}}{{S}_{sub}} , \frac{pN}{{T}_{s}} = \frac{{z}_{1}}{{S}_{sub} {T}_{s}} + \frac{{N}_{τ} N}{{T}_{s}} \qquad ( 12 )$$

Substituting

$$p = \frac{{Nz}_{1}}{{S}_{sub}} + {N}_{τ} ,$$

then the term within second summation is:

$${\sum }_{i = 0}^{M - 1} {e}^{j 2 π {f}_{D} {iTS}_{sym}} {e}^{- \frac{j 2 π {f}_{D} {qiS}_{sym}}{M}} {e}^{- \frac{j 2 π {N}_{τ} {F}_{i}}{N}} {e}^{\frac{j 2 π ( \frac{{Nz}_{1}}{{S}_{sub}} + {N}_{τ} ) {F}_{i}}{N}} = {\sum }_{i = 0}^{M - 1} {e}^{j 2 π {f}_{D} {iTS}_{sym}} {e}^{- \frac{j 2 π {f}_{D} {qiS}_{sym}}{M}} {e}^{\frac{j 2 π ( \frac{{Nz}_{1}}{{S}_{sub}} ) {F}_{i}}{N}} = {\sum }_{i = 0}^{M - 1} {e}^{j 2 π {f}_{D} {iTS}_{sym}} {e}^{- \frac{j 2 π {qiS}_{sym}}{M}} {e}^{\frac{j 2 π {z}_{1} {F}_{i}}{{S}_{sub}}} \qquad ( 12 )$$

Different choices of Fᵢ yields different ambiguity peaks. For instance, when Fᵢ is constant over different i, the terms within the first summation obtains maximum values when

$${e}^{j 2 π {f}_{D} {iTS}_{sym}} {e}^{- \frac{j 2 π {qiS}_{sym}}{M}} = 1 ,$$

that is

$${f}_{D} {TS}_{sym} - \frac{{qS}_{sym}}{M} = {z}_{2} ∈ ℤ , \frac{q}{MT} = {f}_{D} - \frac{{z}_{2}}{{S}_{sym} T} .$$

The ghost delay and Doppler in q/MT- and p-axis are

$${f}_{D} - \frac{{z}_{2}}{{S}_{sym} T} and \frac{{Nz}_{1}}{{S}_{sub}} + {N}_{τ} ,$$

respectively, where z₁, z₂≠0,

Taking Fᵢ=mod(i+β₁, S_{sub}), where β₁ ∈{0, 1, . . . S_{sub}−1}, i=0, 1 for another example, the terms within the first summation obtains maximum values when

$${e}^{j 2 π {f}_{D} {iTS}_{sym}} {e}^{- \frac{j 2 π {qiS}_{sym}}{M}} {e}^{\frac{j 2 π {z}_{1} i}{{S}_{sub}}} = 1.$$

### That is,

$${f}_{D} {TS}_{sym} - \frac{{qS}_{sym}}{M} + \frac{{z}_{1}}{{S}_{sub}} = {z}_{2} ∈ ℤ , \frac{q}{MT} = {f}_{D} - \frac{{z}_{2}}{{S}_{sym} T} + \frac{{z}_{1}}{{S}_{sub} {S}_{sym} T} .$$

Thus, the ghost delay and Doppler in q/MT- and p-axis are

$${f}_{D} - \frac{{z}_{2}}{{S}_{sym} T} + \frac{{z}_{1}}{{S}_{sub} {S}_{sym} T} and \frac{{Nz}_{1}}{{S}_{sub}} + {N}_{τ} ,$$

respectively, where z₂≠0.
Case 1: No staggering, Fᵢ=Fⱼ=constant for any i-th symbol, and j-th symbol.

The side peak locations are

$$( τ + \frac{{lT}_{s}}{{S}_{sub}} , f + \frac{k}{{S}_{sym} T} )$$

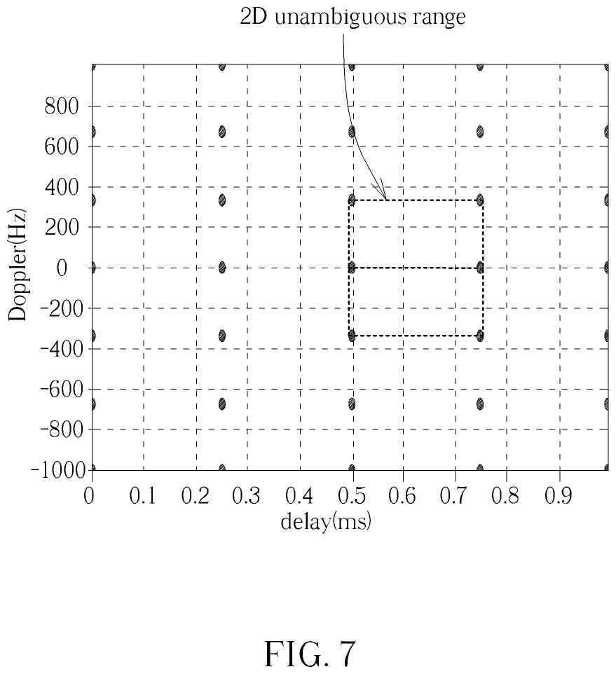

in the 2D ambiguity function, where l=S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) is a true delay and Doppler frequency pair. Some examples are shown in FIG. 4 (S_{sub}=4, S_{sym}=1, Fᵢ=Fⱼ=0) and FIG. 7 (S_{sub}=4, S_{sym}=3, Fᵢ=Fⱼ=0).

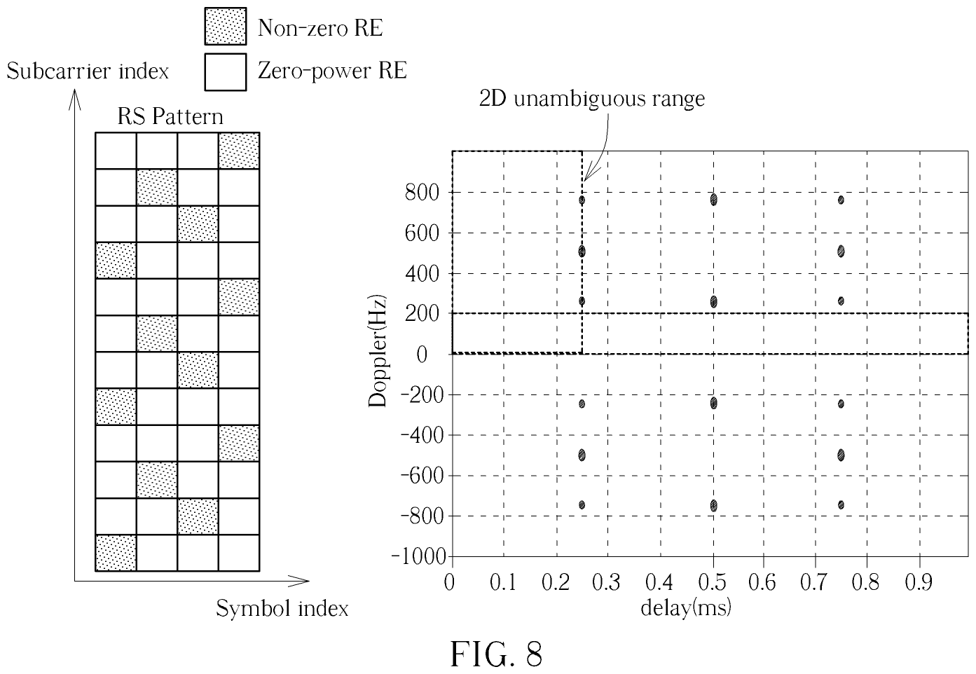

Depending on the application scenarios, different options of the maximum unambiguous 2-D range around the main peak (0,0) may be (FIG. 8 illustrates an example of maximum unambiguous 2-D range):

$$\frac{{lT}_{s}}{{S}_{sub}} + {T}_{cp} ,$$

When l=0 or 1, the supported time delay is from 0 to but the 2D unambiguous range only supports time delay from 0 to

$$min ( \frac{{T}_{s}}{{S}_{sub}} , \frac{{lT}_{s}}{{S}_{sub}} + {T}_{cp} ) ,$$

Doppler frequency from I to

$$\{ \begin{matrix}min ( {f}_{max} , I + \frac{1}{{S}_{sym} T} ) , & when I + \frac{1}{{S}_{sym} T} > 0 \\ max ( - {f}_{max} , I + \frac{1}{{S}_{sym} T} ) , & when I + \frac{1}{{S}_{sym} T} < 0\end{matrix} ,$$

where I is a specified value and

$$max ( - {f}_{max} , - \frac{1}{{S}_{sym} T} ) \leq I \leq 0.$$

Case 2: Staggering offset similar to position reference signal (PRS):

Depending on the application scenarios and choices of l, the maximum 2D unambiguous range around the main peak (0,0) may be: (FIG. 6 shows an example of maximum 2D unambiguous range)
1) When l<2, the supported time delay is from 0 to

$$\frac{{lT}_{s}}{{S}_{sub}} + {T}_{cp} ,$$

but the 2D unambiguous range only supports time delay from 0 to

$$min ( \frac{{T}_{s}}{{S}_{sub}} , \frac{{lT}_{s}}{{S}_{sub}} + {T}_{cp} ) ,$$

Doppler frequency from I to

$$\{ \begin{matrix}min ( {f}_{max} , I + \frac{1}{{S}_{sym} T} ) , & when I + \frac{1}{{S}_{sym} T} > 0 \\ max ( - {f}_{max} , I + \frac{1}{{S}_{sym} T} ) , & when I + \frac{1}{{S}_{sym} T} < 0\end{matrix} ,$$

where I is a specified value and

$$max ( - {f}_{max} , - \frac{1}{{S}_{sym} T} ) \leq I \leq 0 ;$$

2) When l>0, the supported time delay is from 0

$$min ( {T}_{cp} + \frac{{lT}_{s}}{N} , {T}_{s} ) ,$$

Doppler frequency from J to

$$\{ \begin{matrix}min ( {f}_{max} , J + \frac{1}{{S}_{sym} {S}_{sub} T} ) , & when J + \frac{1}{{S}_{sym} {S}_{sub} T} > 0 \\ max ( - {f}_{max} , J + \frac{1}{{S}_{sym} {S}_{sub} T} ) , & when J + \frac{1}{{S}_{sym} {S}_{sub} T} < 0\end{matrix} ,$$

where J is a specified value and

$$max ( - {f}_{max} , - \frac{1}{{S}_{sym} {S}_{sub} T} ) \leq J \leq 0.$$

Case 3: Staggering on two RS symbols when S_{sub} is even,

$$( i . e . , {F}_{1} = f , {F}_{2} = {F}_{1} + \frac{{S}_{sub}}{2} , where 0 \leq f < \frac{{S}_{sub}}{2} ) .$$

For m is even, the side peak locations are

$$( τ + \frac{{mT}_{s}}{{S}_{sub}} , f + \frac{k}{{S}_{sym} T} )$$

in the 2D ambiguity functions, where m=−S_{sub}, −(S_{sub}−2), . . . 0, . . . S_{sub}−2, S_{sub}, k=−S_{sym}, −(S_{sym}−1), . . . 0, . . . S_{sym}−1, S_{sym}, and (τ, f) is a true delay and Doppler frequency pair;
For m is odd, the side peak locations are

$$( τ + \frac{{mT}_{s}}{{S}_{sub}} , f + \frac{\frac{1}{2} + k}{{S}_{sym} T} )$$

in the 2D ambiguity functions, where m=−(S_{sub}−1), −(S_{sub}−3), . . . 1, . . . S_{sub}−3, S_{sub}−1, k=−S_{sym}, −(S_{sym}−1), . . . 0, . . . S_{sym}−1, S_{sym}, and (τ, f) is a true delay and Doppler frequency pair.

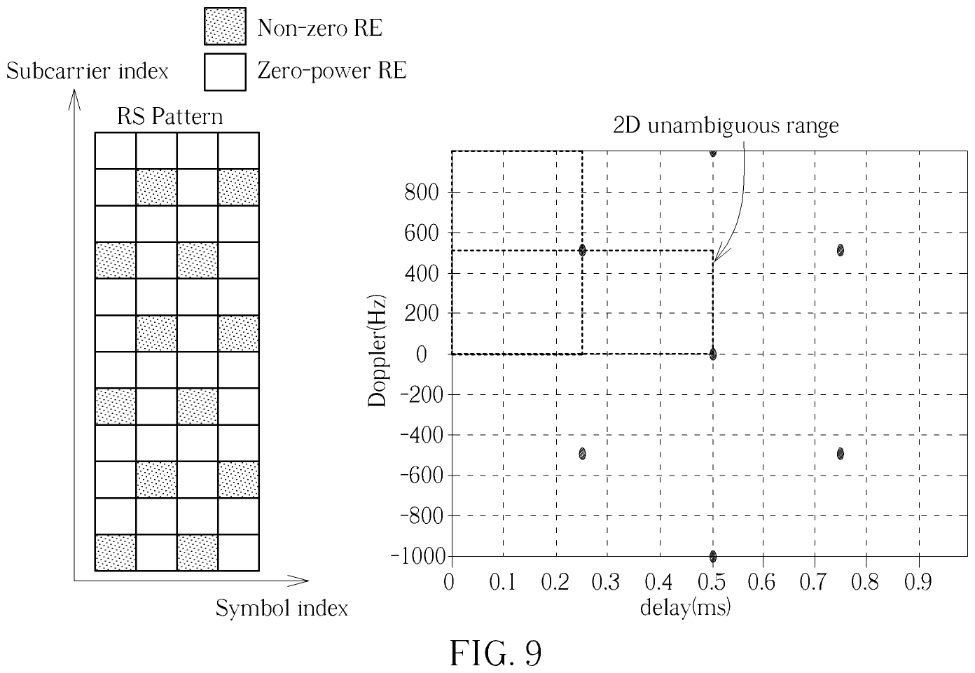

FIG. 9 illustrates an example of S_{sub}=4, S_{sym}=1, F₁=0, F₂=2. Depending on the application scenarios and different choices of l, the maximum 2D unambiguous range around the main peak (0,0) may be:
1) When l<2, the supported time delay is from 0 to

$$\frac{{lT}_{s}}{{S}_{sub}} + {T}_{cp} ,$$

the 2D unambiguous range supports time delay from 0 to

$$min ( \frac{{T}_{s}}{{S}_{sub}} , \frac{{lT}_{s}}{{S}_{sub}} + {T}_{cp} ) ,$$

Doppler frequency from I to

$$\{ \begin{matrix}min ( {f}_{max} , I + \frac{1}{{S}_{sym} T} ) , & when I + \frac{1}{{S}_{sym} T} > 0 \\ max ( - {f}_{max} , I + \frac{1}{{S}_{sym} T} ) , & when I + \frac{1}{{S}_{sym} T} < 0\end{matrix} ,$$

where I is a specified value and

$$max ( - {f}_{max} , - \frac{1}{{S}_{sym} T} ) \leq I \leq 0 ;$$

2) When l≥0, the 2D unambiguous range supports time delay from 0 to

$$min ( \frac{2 {T}_{s}}{{S}_{sub}} , {T}_{cp} + \frac{{lT}_{s}}{{S}_{sub}} ) ,$$

Doppler frequency from J to

$$\{ \begin{matrix}min ( {f}_{max} , J + \frac{1}{2 {S}_{sym} T} ) , & when J + \frac{1}{2 {S}_{sym} T} > 0 \\ max ( - {f}_{max} , J + \frac{1}{2 {S}_{sym} T} ) , & when J + \frac{1}{2 {S}_{sym} T} < 0\end{matrix} ,$$

where is a specified value and

$$max ( - {f}_{max} , - \frac{1}{2 {S}_{sym} T} ) \leq J \leq 0.$$

Case 4: Fᵢ=mod(i+β₁, S_{sub}), i=0, 1, . . . , S_{sub}−1, β₁ ∈{0, 1, . . . S_{sub}−1}, where i denotes the iₜₕ RS symbol.

The side peak locations are

$$( τ + \frac{{mT}_{s}}{{S}_{sub}} , f + \frac{m}{{S}_{sub} {S}_{sym} T} + \frac{k}{{S}_{sym} T} )$$

in the 2D ambiguity functions where m=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) is a true delay and Doppler frequency pair.

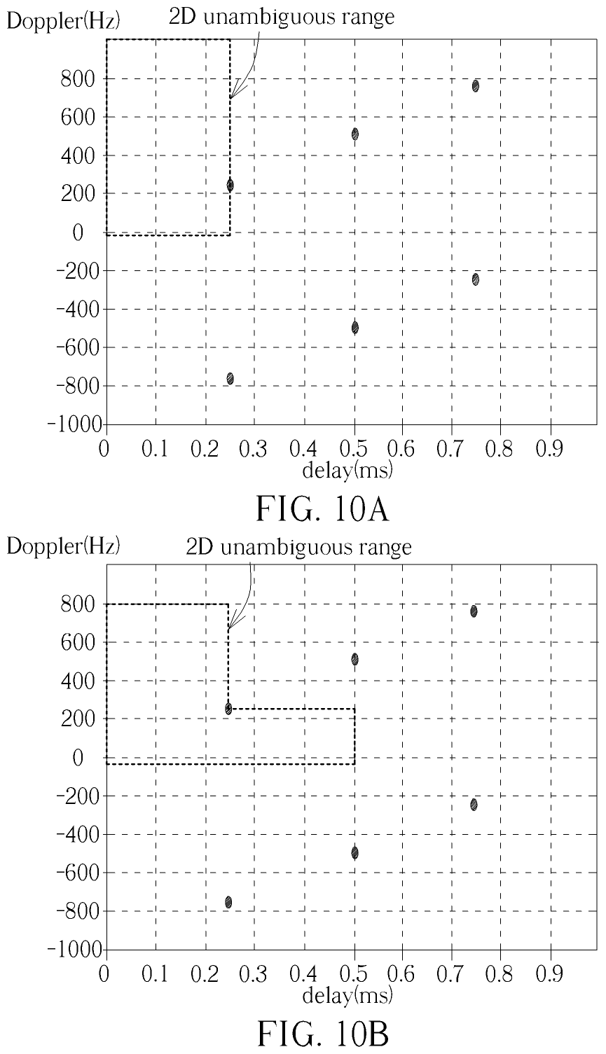

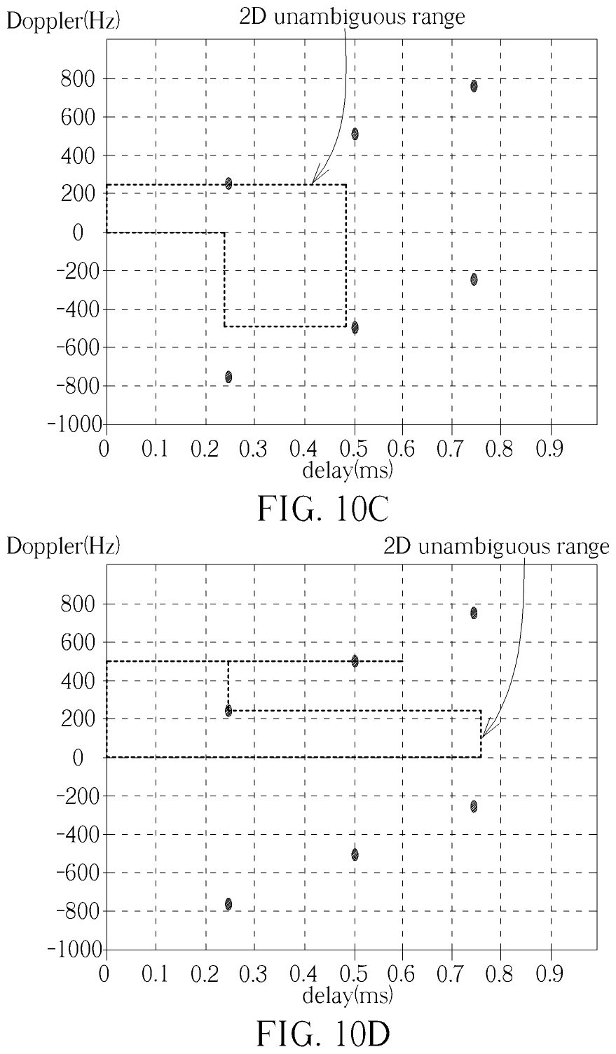

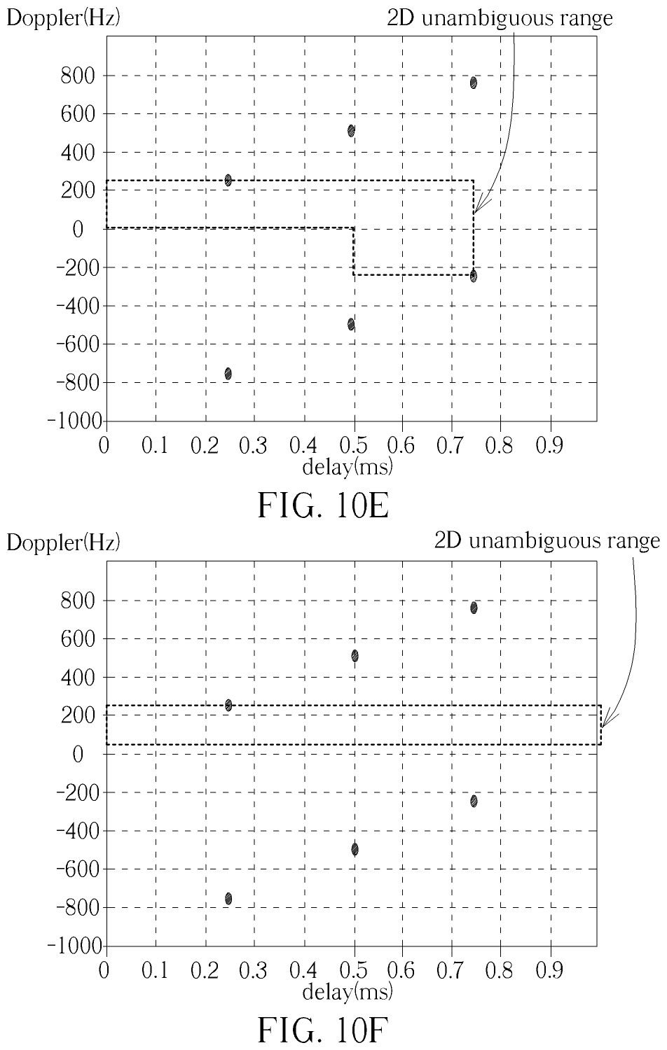

Depending on the application scenarios and different choices of l, the maximum 2D unambiguous range around the main peak (0,0) shows enhanced flexibility of tuning the maximum unambiguous Doppler frequency and time delay. FIGS. 10(a), 10(b), 10(c), 10(d), 10(e), 10(f) shows several examples of 2D unambiguous ranges in the case of S_{sub}=4, S_{sym}=1 with F₁, F₂, F₃, F₄=0, 1, 2, 3.
1) When l<2, the supported time delay is from 0 to

$$\frac{{lT}_{s}}{{S}_{sub}} + {T}_{cp} ,$$

but the 2D unambiguous range only supports time delay from 0 to

$$min ( \frac{{T}_{s}}{{S}_{sub}} , \frac{{lT}_{s}}{{S}_{sub}} + {T}_{cp} ) ,$$

Doppler frequency from I to

$$\{ \begin{matrix}min ( {f}_{max} , I + \frac{1}{{S}_{sym} T} ) , & when I + \frac{1}{{S}_{sym} T} > 0 \\ max ( - {f}_{max} , I + \frac{1}{{S}_{sym} T} ) , & when I + \frac{1}{{S}_{sym} T} < 0\end{matrix} ,$$

where I is a specified value and

$$max ( - {f}_{max} , - \frac{1}{{S}_{sym} T} ) \leq I \leq 0$$

as indicated in FIG. 10(a);
2) When

$${T}_{cp} + \frac{l}{{S}_{sub}} {T}_{s} \geq {T}_{s} ,$$

the 2D unambiguous range supports time delay from 0 to Tₛ, Doppler frequency (f_{d}) from J to

$$\{ \begin{matrix}min ( {f}_{max} , J + \frac{1}{{S}_{sym} {S}_{sub} T} ) , & when J + \frac{1}{{S}_{sym} {S}_{sub} T} > 0 \\ max ( - {f}_{max} , J + \frac{1}{{S}_{sym} {S}_{sub} T} ) , & when J + \frac{1}{{S}_{sym} {S}_{sub} T} < 0\end{matrix} ,$$

where J is a specified value and

$$max ( - {f}_{m a x} , - \frac{1}{{S}_{sym} {S}_{sub} T} ) \leq J \leq 0 ,$$

as indicated by an instance in FIG. 10(f);
3) When l>1, and

$${T}_{cp} + \frac{l}{{S}_{sub}} {T}_{s} < {T}_{s} ,$$

supported time delay (τ) is from 0 to

$${T}_{cp} + \frac{{lT}_{s}}{{S}_{sub}} ,$$

$$and$$

$$\frac{{kT}_{s}}{{S}_{sub}} \geq {T}_{cp} + \frac{{lT}_{s}}{{S}_{sub}}$$

$$and$$

$$\frac{( k - 1 ) {T}_{s}}{{S}_{sub}} < {T}_{cp} + \frac{{lT}_{s}}{{S}_{sub}} ,$$

where k=2, . . . S_{sub}−1. The 2D maximum unambiguous range may be expressed as

$$\{ \begin{matrix}J < {f}_{d} < min ( {f}_{m a x} , J + \frac{{S}_{sub} - k + 1}{{S}_{sub} {S}_{sym} T} ) , 0 < τ < \frac{{T}_{s}}{{S}_{sub}} \\ J < {f}_{d} < min ( {f}_{m a x} , J + \frac{1}{{S}_{sub} {S}_{sym} T} ) , \frac{{T}_{s}}{{S}_{sub}} \leq τ < {T}_{cp} + \frac{{lT}_{s}}{{S}_{sub}}\end{matrix} ,$$

where J is a specified value and

$$max ( - {f}_{m a x} , - \frac{1}{{S}_{sym} {S}_{sub} T} ) \leq J \leq 0 ,$$

as shown in FIG. 10(b) and FIG. 10(d).

$$Or$$

$$\{ \begin{matrix}max ( - {f}_{m a x} , J - \frac{{S}_{sub} - k}{{S}_{sub} {S}_{sym} T} ) < {f}_{d} < min ( {f}_{m a x} , J + \frac{1}{{S}_{sub} {S}_{sym} T} ) , \frac{( k - 1 ) {T}_{s}}{{S}_{sub}} \leq τ < {T}_{cp} + \frac{{lT}_{s}}{{S}_{sub}} \\ J < {f}_{d} < min ( {f}_{m a x} , J + \frac{1}{{S}_{sub} {S}_{sym} T} ) , 0 < τ < \frac{( k - 1 ) {T}_{s}}{{S}_{sub}}\end{matrix} ,$$

where J is a specified value and

$$max ( - {f}_{m a x} , - \frac{1}{{S}_{sym} {S}_{sub} T} ) \leq J \leq 0 ,$$

as shown in FIG. 10(c) and FIG. 10(e).
   Case 5: Fᵢ=mod(S_{sub}−1−i+β₁, S_{sub}), i=0, 1, . . . , S_{sub}−1, β₁ ∈{0, 1, . . . . S_{sub}−1}, where i denotes the iₜₕ RS symbol.

The peak locations are

$$( τ + \frac{{mT}_{s}}{{S}_{sub}} , f - \frac{m}{{S}_{sub} {S}_{sym} T} + \frac{k}{{S}_{sym} T} )$$

in the 2D ambiguity functions, where m=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) is a true delay and Doppler frequency pair.

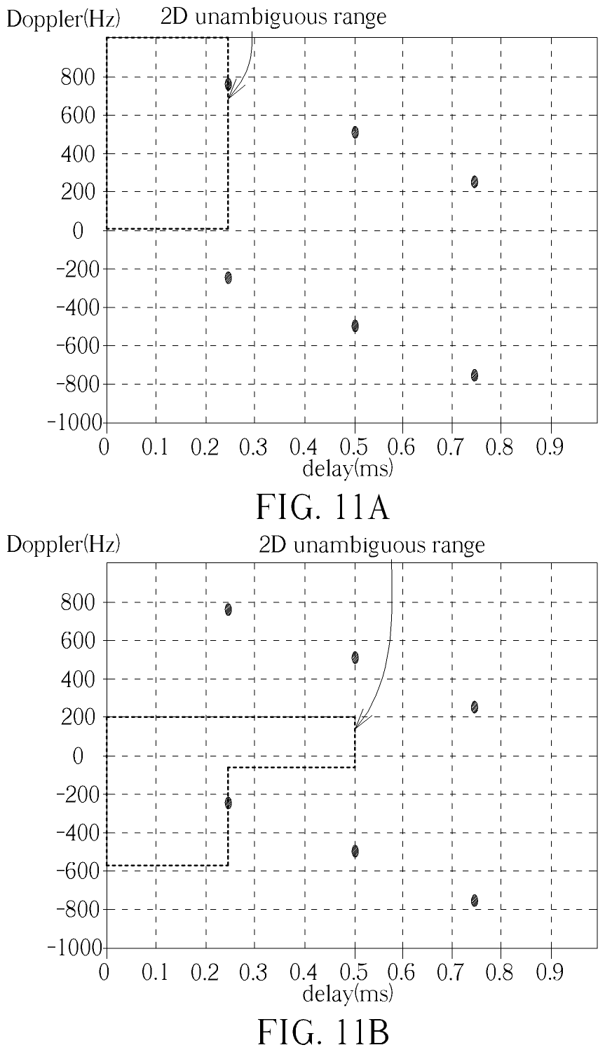

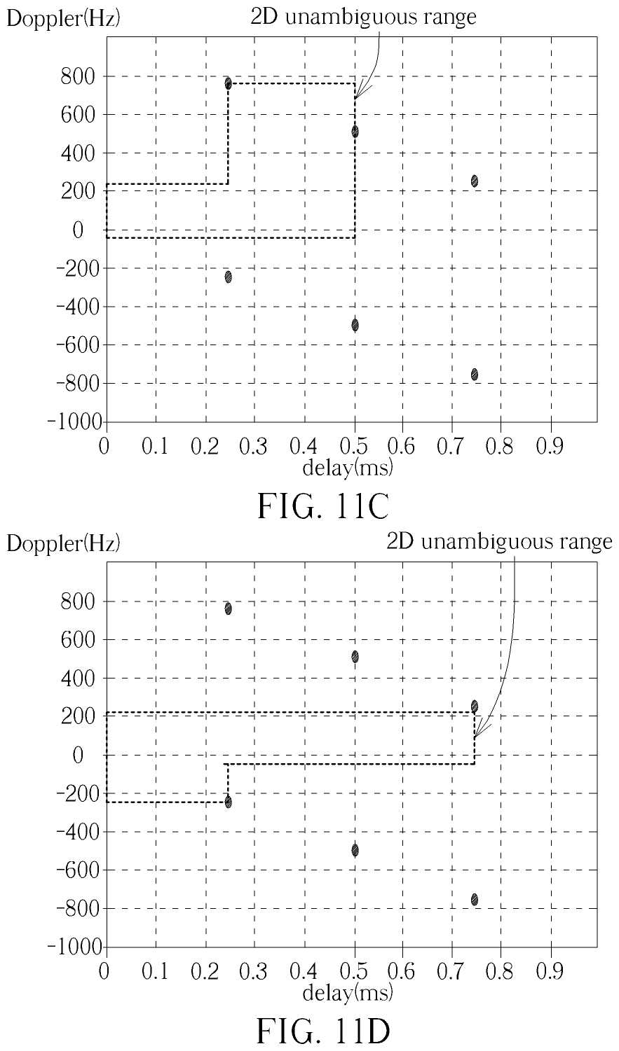

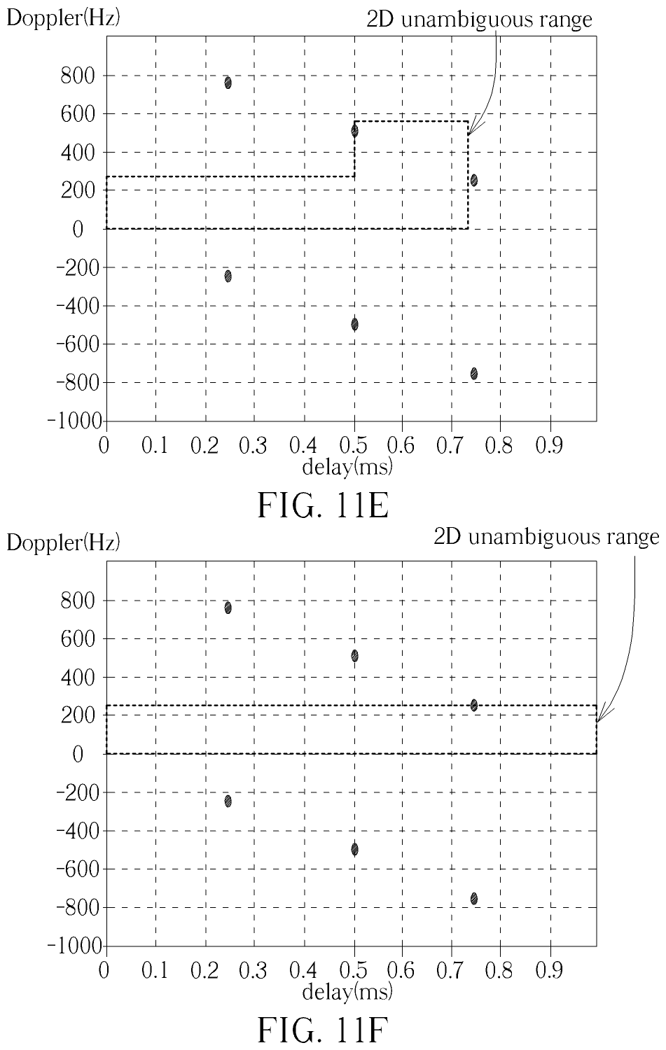

Depending on the application scenarios and different choices of l, the maximum unambiguous 2-D range around the main peak (0,0) shows enhanced flexibility of tuning the maximum unambiguous Doppler frequency and time delay. FIGS. 11(a), 11(b), 11(c), 11(d), 11(e), 11(f) show several examples of 2D unambiguous ranges in the case of S_{sub}=4, S_{sym}=1 with F₁, F₂, F₃, F₄=3, 2, 1, 0.
1) When l<2, the supported time delay is from 0 to

$$\frac{{lT}_{s}}{{S}_{sub}} + {T}_{cp} ,$$

but the 2D unambiguous range only supports time delay from 0 to

$$min ( \frac{{T}_{s}}{{S}_{sub}} , \frac{{lT}_{s}}{{S}_{sub}} + {T}_{cp} ) ,$$

Doppler frequency from I to

$$\{ \begin{matrix}min ( {f}_{m a x} , I + \frac{1}{{S}_{sym} T} ) , when I + \frac{1}{{S}_{sym} T} > 0 \\ max ( - {f}_{m a x} , I + \frac{1}{{S}_{sym} T} ) , when I + \frac{1}{{S}_{sym} T} < 0\end{matrix} ,$$

where I is a specified value and

$$max ( - {f}_{m a x} , - \frac{1}{{S}_{sym} T} ) \leq I \leq 0.$$

FIG. 11(a) illustrates an example;
2) When

$${T}_{cp} + \frac{l}{{S}_{sub}} {T}_{s} \geq {T}_{s} ,$$

the 2D unambiguous range supports time delay from 0 to Tₛ, Doppler frequency (f_{d}) from J to

$$\{ \begin{matrix}min ( {f}_{m a x} , J + \frac{1}{{S}_{sym} {S}_{sub} T} ) , when J + \frac{1}{{S}_{sym} {S}_{sub} T} > 0 \\ max ( - {f}_{m a x} , J + \frac{1}{{S}_{sym} {S}_{sub} T} ) , when J + \frac{1}{{S}_{sym} {S}_{sub} T} < 0\end{matrix} ,$$

where J is a specified value and

$$max ( - {f}_{m a x} , - \frac{1}{{S}_{sym} {S}_{sub} T} ) \leq J \leq 0 ,$$

as indicated by an instance in FIG. 11(f).
3) When l>1, and

$${T}_{cp} + \frac{l}{{S}_{sub}} {T}_{s} < {T}_{s} ,$$

the supported time delay (τ) is from 0 to

$${T}_{cp} + \frac{{lT}_{s}}{{S}_{sub}} , and \frac{{kT}_{s}}{{S}_{sub}} \geq {T}_{cp} + \frac{{lT}_{s}}{{S}_{sub}} and \frac{( k - 1 ) {T}_{s}}{{S}_{sub}} < {T}_{cp} + \frac{{lT}_{s}}{{S}_{sub}} ,$$

where k=2, . . . . S_{sub}−1. The maximum 2D unambiguous range may be expressed as

$$\{ \begin{matrix}max ( - {f}_{max} , J - \frac{{S}_{sub} - k}{{S}_{sub} {S}_{sym} T} ) < {f}_{d} < min ( {f}_{max} , J + \frac{1}{{S}_{sub} {S}_{sym} T} ) , & 0 < τ < \frac{{T}_{s}}{{S}_{sub}} \\ J < {f}_{d} < min ( {f}_{max} , J + \frac{1}{{S}_{sub} {S}_{sym} T} ) , & \frac{{T}_{s}}{{S}_{sub}} \leq τ < {T}_{cp} + \frac{{lT}_{s}}{{S}_{sub}}\end{matrix} ,$$

where J is a specified value and

$$max ( - {f}_{max} , - \frac{1}{{S}_{sym} {S}_{sub} T} ) \leq J \leq 0 ,$$

as indicated by instances in FIG. 11(b) and FIG. 11(d);

### Or

$$\{ \begin{matrix}J < {f}_{d} < min ( {f}_{max} , \frac{{S}_{sub} - k + 1}{{S}_{sub} {S}_{sym} T} ) , & \frac{( k - 1 ) {T}_{s}}{{S}_{sub}} \leq τ < {T}_{cp} + \frac{{lT}_{s}}{{S}_{sub}} \\ J < {f}_{d} < min ( {f}_{max} , J + \frac{1}{{S}_{sub} {S}_{sym} T} ) , & 0 < τ < \frac{( k - 1 ) {T}_{s}}{{S}_{sub}}\end{matrix} ,$$

where J is a specified value and

$$max ( - {f}_{max} , - \frac{1}{{S}_{sym} {S}_{sub} T} ) \leq J \leq 0 ,$$

as indicated by instances in FIG. 11(c) and FIG. 11(e).

Therefore, according to the above embodiments of the configurations, distance and velocity detection of the communication system RS patterns in radar engineering are considered and the configuration parameters of the distance (i.e. the delay)-velocity (i.e. Doppler shift detection) ambiguity function peaks may be adapted.

Notably, those skilled in the art may properly design the joint sensing method and the UE according to different system requirements, which are not limited thereto.

In summary, the present invention provides a joint sensing method and related user equipment (UE) for an orthogonal frequency domain multiplexing (OFDM) communication system to extend a maximum time delay and adapt a maximal unambiguous velocity and distance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A joint sensing method for an orthogonal frequency domain multiplexing (OFDM) communication system, comprising:
performing inverse fast Fourier transform (IFFT) for an OFDM reference signal (RS) symbol to obtain a first plurality of subsets of the OFDM RS symbol;
removing, by a receiver of the OFDM communication system, cyclic prefix (CP) of a plurality of resource elements (RE) of the OFDM RS symbol and at least one of the first plurality of subsets of the OFDM RS symbol to obtain a second plurality of subsets of the OFDM RS symbol;
performing, by the receiver of the OFDM communication system, a phase compensation for the second plurality of subsets of the OFDM RS symbol to obtain the third plurality of subsets of the OFDM RS symbol; and
performing, by the receiver of the OFDM communication system, fast Fourier transform (FFT) for the third plurality of subsets of the OFDM RS symbol;
wherein the OFDM RS symbol is of a comb structure.

2. The joint sensing method of claim 1, wherein the OFDM RS symbol is divided into S_{sub} subsets.

3. The joint sensing method of claim 1, wherein for any subsets Yᵢ and Yⱼ (i≠j) of the plurality of subsets of the OFDM RS symbol, a difference between Yᵢ and Yⱼ is a constant phase rotation, and a maximum time delay is extended according to an OFDM symbol duration and a CP time duration.

4. The joint sensing method of claim 3, wherein the procedure of removing CP of a plurality of resource elements (RE) of the OFDM RS symbol and at least one of the first plurality of subsets of the OFDM RS symbol further comprising:
removing CP and an extended CP to obtain the second plurality of subsets of the OFDM RS symbol, wherein the extended CP is one of the following: Y₁, Y₁ and Y₂, and Y₁, Y₂ and Y₃.

5. The joint sensing method of claim 1, wherein S_{sub} unit in a subcarrier number denotes a spacing of a plurality of non-zero resource elements (RE) in a frequency domain, S_{sym} unit in a symbol number denotes the spacing of the RS symbol in the time domain, Fᵢ unit in a subcarrier numbers denotes a staggering offset in the frequency domain of an iₜₕ RS symbol, Fⱼ unit in the subcarrier numbers denotes the staggering offset in the frequency domain of an jₜₕ RS symbol, Tₛ denotes an OFDM duration, T_{cp} denotes a cyclic prefix (CP) duration, and T=Tₛ+T_{cp} denotes a sum of the OFDM symbol duration and the CP duration.

6. The joint sensing method of claim 5, wherein when no staggering, Fᵢ=Fⱼ=constant for any i-th symbol, and j-th symbol, a plurality of side peak locations are
$$( τ + \frac{{lT}_{s}}{{S}_{sub}} , f + \frac{k}{{S}_{sym} T} )$$
in a plurality of 2D ambiguity functions, where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) denotes a true delay and Doppler frequency pair.

7. The joint sensing method of claim 5, wherein when the staggering offset is similar to position reference signal (PRS), a maximum 2D unambiguous range around the main peak (0,0) are:
when l<2, the supported time delay is from 0 to
$$\frac{{lT}_{s}}{{S}_{sub}} + {T}_{cp} ,$$
the maximum 2D unambiguous range only supports time delay from 0 to
$$min ( \frac{{T}_{s}}{{S}_{sub}} , \frac{{lT}_{s}}{{S}_{sub}} + {T}_{cp} ) ,$$
Doppler frequency from I to
$$\{ \begin{matrix}min ( {f}_{max} , I + \frac{1}{{S}_{sym} T} ) , & when I + \frac{1}{{S}_{sym} T} > 0 \\ max ( - {f}_{max} , I + \frac{1}{{S}_{sym} T} ) , & when I + \frac{1}{{S}_{sym} T} < 0\end{matrix} ,$$
where I is a specified value and
$$max ( - {f}_{max} , - \frac{1}{{S}_{sym} T} ) \leq I \leq 0 ;$$
when l>0, the supported time delay is from 0 to
$$min ( {T}_{cp} + \frac{{lT}_{s}}{N} , {T}_{s} ) ,$$
Doppler frequency from J to
$$\{ \begin{matrix}min ( {f}_{max} , J + \frac{1}{{S}_{sym} {S}_{sub} T} ) , & when J + \frac{1}{{S}_{sym} {S}_{sub} T} > 0 \\ max ( - {f}_{max} , J + \frac{1}{{S}_{sym} {S}_{sub} T} ) , & when J + \frac{1}{{S}_{sym} {S}_{sub} T} < 0\end{matrix} ,$$
where J is a specified value and
$$max ( - {f}_{max} , - \frac{1}{{S}_{sym} {S}_{sub} T} ) \leq J \leq 0 ;$$
and
wherein l denotes the maximum time delay, fₘₐₓ denotes a maximum Doppler frequency and N denotes a length of the RS symbol.

8. The joint sensing method of claim 5, wherein when the staggering offset on two RS symbols and the S_{sub} is even:
for m is even, the plurality of side peak locations are
$$( τ + \frac{{mT}_{s}}{{S}_{sub}} , f + \frac{k}{{S}_{sym} T} )$$
in a plurality of 2D ambiguity functions, where m=−S_{sub}, −(S_{sub}−2), . . . 0, . . . S_{sub}−2, S_{sub}, k=−S_{sym}, −(S_{sym}−1), . . . 0, . . . S_{sym}−1, S_{sym}, and (τ, f) is a true delay and Doppler frequency pair; and
for m is odd, the plurality of side peak locations are
$$( τ + \frac{m {T}_{s}}{{S}_{sub}} , f + \frac{\frac{1}{2} + k}{{S}_{sym} T} )$$
in the plurality of 2D ambiguity functions, where m=−(S_{sub}−1), −(S_{sub}−3), . . . 1, . . . S_{sub}−3, S_{sub}−1, k=−S_{sym}, −(S_{sym}−1), . . . 0, . . . S_{sym}−1, S_{sym}, and (τ, f) is a true delay and Doppler frequency pair.

9. The joint sensing method of claim 5, wherein Fᵢ=mod(i+β₁, S_{sub}), i=0, 1, . . . , S_{sub}−1, β₁∈{0, 1, . . . S_{sub}−1}, where i denotes the iₜₕ RS symbol, a plurality of side peak locations are
$$( τ + \frac{m {T}_{s}}{{S}_{sub}} , f + \frac{m}{{S}_{sub} {S}_{sym} T} + \frac{k}{{S}_{sym} T} )$$
in a plurality of 2D ambiguity functions, where m=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) is a true delay and Doppler frequency pair.

10. The joint sensing method of claim 5, wherein Fᵢ=mod(S_{sub}−1−i+β₁, S_{sub}), i=0, 1, . . . , S_{sub}−1, β₁ ∈{0, 1, . . . S_{sub}−1}, where i denotes the iₜₕ RS symbol, a plurality of peak locations are
$$( τ + \frac{m {T}_{s}}{{S}_{sub}} , f - \frac{m}{{S}_{sub} {S}_{sym} T} + \frac{k}{{S}_{sym} T} )$$
in a plurality of 2D ambiguity functions, where m=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) is a true delay and Doppler frequency pair.

11. A user equipment (UE) of an orthogonal frequency domain multiplexing (OFDM) communication system, comprising:
a wireless transceiver, configured to receive a first plurality of subsets of the OFDM RS symbol from a service network; and
a controller, configured to remove cyclic prefix (CP) of a plurality of resource elements (RE) of an OFDM reference signal (RS) symbol and at least one of the first plurality of subsets of the OFDM RS symbol to obtain a second plurality of subsets of the OFDM RS symbol; to perform a phase compensation for the second plurality of subsets of the OFDM RS symbol to obtain the third plurality of subsets of the OFDM RS symbol;
and to perform fast Fourier transform (FFT) for the third plurality of subsets of the OFDM RS symbol;
wherein the OFDM RS symbol is of a comb structure.

12. The UE of an OFDM communication system of claim 11, wherein the OFDM RS symbol is divided into S_{sub} subsets.

13. The UE of an OFDM communication system of claim 11, wherein for any subsets Yᵢ and Yⱼ (i≠j) of the plurality of subsets of the OFDM RS symbol, a difference between Yᵢ and Yⱼ is a constant phase rotation, a maximum time delay is extended according to an OFDM symbol duration and a CP time duration.

14. The UE of an OFDM communication system of claim 13, further comprising:
removing CP and an extended CP to obtain the second plurality of subsets of the OFDM RS symbol, wherein the extended CP is one of the following: Y₁, Y₁ and Y₂, and Y₁, Y₂ and Y₃.

15. The UE of an OFDM communication system of claim 11, wherein S_{sub} unit in a subcarrier number denotes a spacing of a plurality of non-zero resource elements (RE) in a frequency domain, S_{sym} unit in a symbol number denotes the spacing of the RS symbol in the time domain, Fᵢ unit in a subcarrier numbers denotes a staggering offset in the frequency domain of an iₜₕ RS symbol, Fⱼ unit in the subcarrier numbers denotes the staggering offset in the frequency domain of an jₜₕ RS symbol, Tₛ denotes an OFDM duration, T_{cp} denotes a cyclic prefix (CP) duration, and T=Tₛ+T_{cp} denotes a sum of the OFDM symbol duration and the CP duration.

16. The UE of an OFDM communication system of claim 15, wherein when no staggering, Fᵢ=Fⱼ=constant for any i-th symbol, and j-th symbol, a plurality of side peak locations are
$$( τ + \frac{{lT}_{s}}{{S}_{sub}} , f + \frac{k}{{S}_{sym} T} )$$
n a plurality of 2D ambiguity functions, where l=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) denotes a true delay and Doppler frequency pair.

17. The UE of an OFDM communication system of claim 15, wherein when the staggering offset is similar to position reference signal (PRS), a maximum 2D unambiguous range around the main peak (0,0) are:
when l<2, the supported time delay is from 0 to
$$\frac{{lT}_{s}}{{S}_{sub}} + {T}_{cp} ,$$
the maximum 2D unambiguous range only supports time delay from 0 to
$$min ( \frac{{T}_{s}}{{S}_{sub}} , \frac{{lT}_{s}}{{S}_{sub}} + {T}_{c p} ) ,$$
Doppler frequency from I to
$$\{ \begin{matrix}min ( {f}_{max} , I + \frac{1}{{S}_{sym} T} ) , when I + \frac{1}{{S}_{sym} T} > 0 \\ max ( - {f}_{max} , I + \frac{1}{{S}_{sym} T} ) , when I + \frac{1}{{S}_{sym} T} < 0\end{matrix} ,$$
where I is a specified value and
$$max ( - {f}_{max} , - \frac{1}{{S}_{sym} T} ) \leq 1 \leq 0 ;$$
and
when l>0, the supported time delay is from 0 to
$$min ( {T}_{c p} + \frac{{lT}_{s}}{N} , {T}_{s} ) ,$$
Doppler frequency from J to
$$\{ \begin{matrix}min ( {f}_{max} , J + \frac{1}{{S}_{sym} {S}_{sub} T} ) , when J + \frac{1}{{S}_{sym} {S}_{sub} T} > 0 \\ max ( - {f}_{max} , J + \frac{1}{{S}_{sym} {S}_{sub} T} ) , when J + \frac{1}{{S}_{sym} {S}_{sub} T} < 0\end{matrix} ,$$
where J is a specified value and
$$max ( - {f}_{max} , - \frac{1}{{S}_{sym} {S}_{sub} T} ) \leq J \leq 0 ;$$
wherein l denotes the maximum time delay, fₘₐₓ denotes a maximum Doppler frequency and N denotes a length of the RS symbol.

18. The UE of an OFDM communication system of claim 15, wherein when the staggering offset on two RS symbols and the S_{sub} is even:
for m is even, the plurality of side peak locations are
$$( τ + \frac{m {T}_{s}}{{S}_{sub}} , f + \frac{k}{{S}_{sym} T} )$$
in a plurality of 2D ambiguity functions, where m=−S_{sub}, −(S_{sub}−2), . . . 0, . . . S_{sub}−2, S_{sub}, k=−S_{sym}, −(S_{sym}−1), . . . 0, . . . S_{sym}−1, S_{sym}, and (τ, f) is a true delay and Doppler frequency pair; and
for m is odd, the plurality of side peak locations are
$$( τ + \frac{m {T}_{s}}{{S}_{sub}} , f + \frac{\frac{1}{2} + k}{{S}_{sym} T} )$$
in the plurality of 2D ambiguity functions, where m=−(S_{sub}−1), −(S_{sub}−3), . . . 1, . . . S_{sub}−3, S_{sub}−1, k=−S_{sym}, −(S_{sym}−1), . . . 0, . . . S_{sym}−1, S_{sym}, and (τ, f) is a true delay and Doppler frequency pair.

19. The UE of an OFDM communication system of claim 15, wherein Fᵢ=mod(i+β₁, S_{sub}), i=0, 1, . . . , S_{sub}−1, β₁ ∈{0, 1, . . . S_{sub}−1}, where i denotes the iₜₕ RS symbol, a plurality of side peak locations are
$$( τ + \frac{m {T}_{s}}{{S}_{sub}} , f + \frac{m}{{S}_{sub} {S}_{sym} T} + \frac{k}{{S}_{sym} T} )$$
in a plurality of 2D ambiguity functions, where m=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) is a true delay and Doppler frequency pair.

20. The UE of an OFDM communication system of claim 15, wherein Fᵢ=mod(S_{sub}−1−i+β₁, S_{sub}), i=0, 1, . . . , S_{sub}−1, β₁ ∈{0, 1, . . . S_{sub}−1}, where i denotes the iₜₕ RS symbol, a plurality of peak locations are
$$( τ + \frac{m {T}_{s}}{{S}_{sub}} , f - \frac{m}{{S}_{sub} {S}_{sym} T} + \frac{k}{{S}_{sym} T} )$$
in a plurality of 2D ambiguity functions, where m=−S_{sub}, −(S_{sub}−1), . . . 0, . . . S_{sub}−1, S_{sub}, k=−S_{sym}, −(S_{sym}−1), . . . 0, . . . S_{sym}−1, S_{sym}, and (τ, f) is a true delay and Doppler frequency pair.
